(19) United States
(12) Patent Application Publication
(10) Pub. No.: US 2011/0290766 A1
(43) Pub. Date: Dec. 1, 2011

(54) SYSTEM AND METHOD FOR FLASH-WELDING

(76) Inventor: Charles R. BATTISTI, Gladstone, MO (US)

(21) Appl. No.: 12/987,581

(22) Filed: Jan. 10, 2011

Related U.S. Application Data
(60) Provisional application No. 61/349,657, filed on May 28, 2010.

(51) Int. Cl. B23K 11/24

(52) U.S. Cl. 219/108

(57) ABSTRACT

An welding system is disclosed. The welding system may have a power supply, a forging arrangement configured to hold and move ends of two components to be welded together, and a plurality of contacts connecting the power supply to the two components. The welding system may also have a controller in communication with the power supply and the forging arrangement. The controller may be configured to regulate the power supply to selectively operate in a constant voltage mode and a constant current mode during different stages of a single weld cycle, and to actuate the forging arrangement to move the ends of the two components together during a final stage of the single weld cycle.

### RELATED APPLICATIONS

This application is based on and claims the benefit of priority from U.S. Provisional Application No. 61/349,657 by Charles R. Battisti, filed May 28, 2010, the contents of which are expressly incorporated herein by reference.

### TECHNICAL FIELD

The present disclosure relates generally to a welding system and method, and more particularly, to a system and method for flash-welding butt joints.

### BACKGROUND

In a continuing effort to produce railroad rails that have a longer installed lifecycle, manufacturers have recently implemented several process improvements. For example, chemistries of the steel rails have become more complex in order to increase wear resistance. In addition, a cross section of the rail has been modified to increase a rail head size. This increased head size allows for more profile grind cycles to be performed before the rail must be taken out of service.

Although the improvements listed above may result in longer installed lifecycles of a typical rail, both of these improvements may also increase difficulties encountered during flash welding of butt joints between the rails. In particular, exotic steel chemistries can pose problems because the addition of alloying elements reduce a conductivity and restrict heat flow, which can affect cratering during flashing and ultimately reduce weld bond integrity. In addition, rail section changes have reduced a symmetry of the cross sectional area. Asymmetry in the rail cross-section can negatively effect a weld current density in different areas on the weld surface, again causing cratering and reducing weld bond integrity. Accordingly, advances in rail welding technology may be required to match industry's continuous improvement efforts.

The disclosed system and method are directed to overcoming one or more of the problems set forth above and/or other problems of the prior art.

### SUMMARY

In one aspect, the present disclosure is directed to a welding system. The welding system may include a power supply, a forging arrangement configured to hold and move ends of two components to be welded together, and a plurality of contacts connecting the power supply to the two components. The welding system may also include a controller in communication with the power supply and the forging arrangement. The controller may be configured to regulate the power supply to selectively operate in a constant voltage mode and a constant current mode during different stages of a single weld cycle, and to actuate the forging arrangement to move the ends of the two components together during a final stage of the single weld cycle.

In another aspect, the present disclosure is directed to a method of flash welding a first component to a second component. The method may include regulating a power supply in a constant current mode of operation to provide power to ends of the first and second components during at least a first stage of a welding cycle, and regulating the power supply in a constant voltage mode of operation to provide power to ends of the first and second components during at least a second stage of the welding cycle. The method may also include moving the first component into the second component during a third stage of the welding cycle.

### BRIEF DESCRIPTION OF THE DRAWINGS

FIG. 1 is a schematic illustration of an exemplary disclosed welding system; and

FIG. 2 is a process chart depicting an exemplary disclosed method that may be performed by the system of FIG. 1.

### DETAILED DESCRIPTION

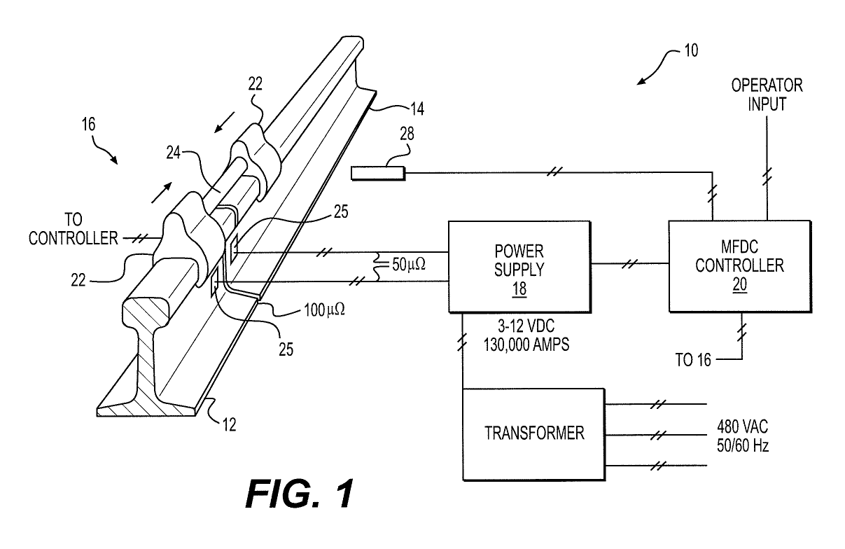

FIG. 1 illustrates a welding system 10 that may be utilized to join two components, for example adjacent ends of two railroad rails 12, 14. Welding system 10 may include a forging arrangement 16, a power supply 18, and a controller 20. As will be explained in more detail below, controller 20 may regulate a voltage and a current directed to rails 12, 14 from power supply 18 to create a permanent flash weld at a butt joint between rails 12, 14.

Forging arrangement 16 may include components that cooperate to move the ends of rails 12, 14 together with extreme force based on a command from controller 20. For example, forging arrangement 16 may include one or more clamps 22 associated with each rail 12, 14, and an actuator 24 that extends between clamps 22. In one embodiment, clamps 22 may be located on an upper crown, a lower base, and a middle web surface of each rail end, although any arrangement and number of clamps 22 may be utilized to grasp the ends of rails 12, 14. Each clamp 22 may be configured to provide a clamping force to securely hold the corresponding rail 12, 14 during a welding process. It is contemplated that clamps 22 of one of rails 12, 14 may be associated with a stationary platen (not shown), while clamps 22 associated with the other of rails 12, 14 may be associated with a movable platen (not shown). Alternatively, clamps 22 associated with each of rails 12, 14 may be associated with movable platens. Actuator 24 may embody a hydraulic actuator connected at each end to clamps 22 and/or to the platens associated with clamps 22. Actuator 24 may be selectively supplied with high-pressure fluid to retract and move rails 12, 14 together or to extend and pull rails 12, 14 apart in response to a command from controller 18. In one embodiment, actuator 24 may be configured to exert forces in a range of about 50-200 tons.

Power supply 18 may be a mid-frequency DC (MFDC) power supply that is pulse width modulation controlled (PWM). An MFDC power supply may be considered an independent power source, as it may be controlled to compensate for variations in changing circuit conditions. Power supply 18 may be operable in two different modes, for example a constant current mode and a constant force mode, and capable of changing between these modes very quickly, for example in 1/2400 of a second.

In the constant current mode, power supply 18 may be controlled to vary an output voltage in order to maintain a preset welding current. As the components being welded heat up, an associated DC resistance through the welded components increases. When the current through the welded components begins to decrease because of the increasing resistance, the current will eventually fall below the preset welding current. In this situation, power supply 18 may be controlled to increase a supply voltage, up to a maximum design amount of about 12 vdc, in an attempt to maintain a constant current through the welded components. As the welding current approaches or exceeds the preset welding current, power supply 18 may be controlled to reduce the supply voltage.

In the constant voltage mode, power supply 18 may be controlled to vary an output current in order to maintain a preset welding voltage. When the voltage through the welded components begins to decrease below the preset welding voltage, power supply 18 may be controlled to increase a supply current, up to a maximum design amount of about 130,000 amps, in an attempt to maintain a constant voltage through the welded components. As the welding voltage approaches or exceeds the preset welding current, power supply 18 may be controlled to reduce the supply current.

Power supply 18 may direct electrical power to rails 12, 14 during the welding process by way of contacts 25 connected to the ends of rails 12, 14. It should be noted that any number and configuration of contacts 25 may be utilized. In one example, pairs of contacts 25 may be utilized on the end of each rail 12, 14 to be welded, and spaced apart on opposing sides of rails 12, 14.

A transformer 26 may be associated with power supply 18, if desired. Transformer 26 may be configured to receive alternating current from a utility or other source, and transform the power according to requirements of power supply 18. In one example, transformer 26 may receive AC power having 480 vac at 50 or 60 hz, and transform the power to direct current power having up to 12 vdc and 130,000 amps.

Controller 20 may be in communication with the components of welding system 10 to regulate flash welding of rails 12, 14 in response to sensory input and/or input from an operator. Controller 20 may embody a single or multiple microprocessors, field programmable gate arrays (FPGAs), digital signal processors (DSPs), etc. that include a means for controlling an operation of forging arrangement 16 and power supply 18 in response to different input signals. It should be appreciated that controller 20 could readily embody a general welding system microprocessor and be capable of controlling numerous welding system functions and modes of operation or, alternatively, be dedicated to controlling only power supply related functions. If separate from the general welding system microprocessor, controller 20 may communicate with the general welding system microprocessor via datalinks or other methods. Numerous commercially available microprocessors can be configured to perform the functions of controller 20. Various known circuits may be associated with controller 20, including power supply circuitry, signal-conditioning circuitry, actuator driver circuitry (i.e., circuitry powering actuator 24, solenoids, motors, etc.), and communication circuitry.

One or more sensors 28 may be associated with welding system 10. For example, sensors 28 may include a voltage and/or current sensor associated with the supply of power to contacts 25, a linear distance and/or velocity transducer associated with movement of rails 12, 14 caused by actuator 24, a pressure transducer associated with the force imparted by actuator 24 on rails 12, 14, a temperature sensor associated with one or both of rails 12, 14, or another sensor known in the art. It is contemplated that the voltage and/or current sensors may be located on a primary side (between power supply 18 and transformer 26) or a secondary side of power supply 18 (between power supply 18 and contacts 25), as desired. Each sensor 28 may be configured to generate a signal indicative of the corresponding measured parameter, and direct the signal to controller 20.

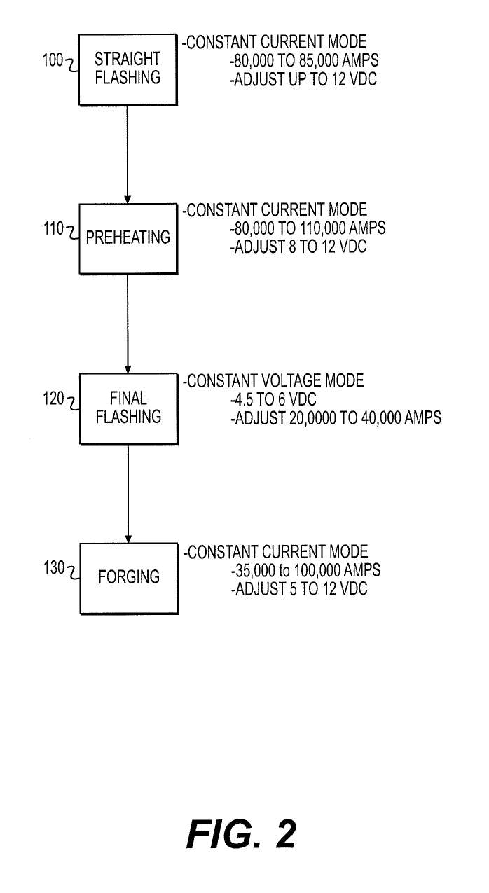

FIG. 2 illustrates an exemplary welding process that may be regulated by controller 20 in response to the sensor input and/or in response to operator input. FIG. 2 will be explained in more detail below to better illustrate the disclosed system and its operation.

### INDUSTRIAL APPLICABILITY

Flash welding of a butt joint can be accomplished in four distinct stages, including a Straight Flashing Stage (shown as step 100 in FIG. 2), a Preheating Stage (shown as step 110), a Final Flashing Stage (shown as step 120), and a Forging Stage (shown as step 130). Controller 20 may regulate operation of power supply 18 and forging arrangement 16 differently during each of these stages to produce a high quality weld between the ends of rails 12, 14.

The Straight Flashing Stage may be considered a preliminary stage at which the ends of rails 12, 14 are prepared for welding. In this stage, power may be supplied to the ends of rails 12, 14 to burn away any irregularities that may exist, thereby making the ends “straight.” Impurities such as rust, dirt, grease, etc. may also be burned away at this time. By straightening the ends of rails 12, 14, it may be ensured that the even heating of the ends may occur and that mill irregularities will not interfere with the welding process.

During the Straight Flashing Stage, controller 20 may regulate power supply 18 to operate in the constant current mode and initiate the weld process. During this stage, in the constant current mode of operation, controller 20 may maintain a high current (e.g., about 80,000 to 85,000 amps) at contacts 25 by selectively adjusting a high voltage (e.g., up to about 12 vdc). These high levels of voltage and current may be required because rails 12, 14 may be initially relatively cold and not predisposed to being easily melted (not readily able to sustain flashing).

The Preheating Stage may be the stage where a majority of a required welding heat is provided to rails 12, 14. This heating can be provided by way of power pulses sent from power supply 18 to contacts 25 on the ends of rails 12, 14, each pulse lasting from about 2-4 seconds, for example. During this stage, the ends of the rails may be brought together by force 16 during the pulsing to help create uniform heating of the rail ends, and then moved apart between the pulses to help ensure that permanent joining is not yet effected. The power may be provided in pulses, as opposed to a constant supply, to help prolong a life of system components.

During the Preheating Stage, controller 20 may also regulate power supply 18 to operate in the constant current mode. In particular, controller 20 may increase the current supplied to contacts 25 during the Preheating Stage (e.g., to about 80,000 to 110,000 amps or higher), and maintain a constant high current by selectively adjusting the voltage of the supply (e.g., between about 8-12 vdc) as rails 12, 14 heat up. This high current may be required to provide high production welding rates with heavy rail sections. It is contemplated that, between pulses in the constant current mode, controller 20 may additionally regulate power supply 18 to operate in the constant voltage mode, if desired.

The Final Flashing Stage may be considered the final heating stage before rails 12, 14 are forced together to form the permanent weld. This heating may also be provided by way of power pulses send from power supply 18 to contacts 25, but at an increasing rate to continually burn away any oxidation that may have occurred on the ends of rails 12, 14 and to fill any cratering caused during previous heating pulses.

During the Final Flashing Stage, controller 20 may regulate power supply 18 to operate in the constant voltage mode. Specifically, controller 20 may reduce the voltage during the Final Flashing Stage (e.g., to between about 4.5-6 vdc), and maintain the low voltage by selectively adjusting the current (e.g., between about 20,000 to 40,000 amps) as heat and resistance in rails 12, 14 changes. In some situations, it may be necessary to initiate the Final Flashing Stage with relatively higher voltage, and then ramp down the voltage to the lower level described above. This low level voltage during the Final Flashing Stage may improve a quality of the resulting weld.

The Forging Stage may be the final step in the welding process (other than quenching), where rails 12, 14 are forced together under extreme pressure by forging arrangement 16. Forging arrangement 16 may be controlled to move rails 12, 14 together until a desired pressure in actuator 24 is achieved and/or until a desired linear movement of rails 12, 14 toward each other is achieved.

During the Forging Stage, controller 20 may regulate power supply 18 to operate in the constant current mode. That is, controller 20 may continue to direct electrical power to contacts 25 with a relatively constant current (e.g., about 35,000 to 100,000 amps) by changing voltage (between about 5-12 vdc) based on changing heat and resistance in rails 12, 14 after forging arrangement 16 has moved rails 12, 14 together.

The disclosed system may have the ability to perform a desired amount of work, with about half the voltage normally used during conventional welding processes. Using half the voltage and the same amount of total power implies that the welding current utilized is virtually doubled (P=I*V). This increased welding current density, along with reduced voltage, may yield high quality rail welds.

The discloses welding system may also be capable of welding rails having different chemical make-ups and/or different rail cross-sections. In particular, the ability to adjust voltage to obtain a desired current in the rails or to adjust current and obtain a desired voltage may allow for process flexibility in temperatures, durations, etc.

It will be apparent to those skilled in the art that various modifications and variations can be made to the disclosed system and method without departing from the scope of the disclosure. Other embodiments of the disclosed system and method will be apparent to those skilled in the art from consideration of the specification and practice of the system and method disclosed herein. It is intended that the specification and examples be considered as exemplary only, with a true scope of the disclosure being indicated by the following claims and their equivalents.

What is claimed is:

1. A welding system, comprising:
a power supply;
a forging arrangement configured to hold and move ends of two components to be welded together;
a plurality of contacts connecting the power supply to the two components; and
a controller in communication with the power supply and the forging arrangement, the controller being configured to:
regulate the power supply to selectively operate in a constant voltage mode and a constant current mode during different stages of a single weld cycle; and
actuate the forging arrangement to move the ends of the two components together during a final stage of the single weld cycle.

2. The welding system of claim 1, wherein the controller is configured to regulate the power supply to selectively operate in the constant voltage mode and the constant current mode based on which stage of the single weld cycle is currently being completed.

3. The welding system of claim 2, wherein:
the single weld cycle includes a straight flashing stage, a preheating stage, a final flashing stage, and a forging stage; and
the controller is configured to regulate the power supply to selectively operate in the constant current mode during the straight flashing, preheating, and forging stages, and in the constant voltage mode during the final flashing stage.

4. The welding system of claim 3, wherein the controller is configured to regulate the power supply to provide electrical power having a current in the range of about 80,000 to 85,000 amps and a voltage in the range of up to about 12 vdc to the plurality of contacts during the straight flashing stage.

5. The welding system of claim 4, wherein the controller is configured to regulate the power supply to provide electrical power having a current in the range of about 80,000 to 100,000 amps and a voltage in the range of about 8 to 12 vdc to the plurality of contacts during the preheating stage.

6. The welding system of claim 5, wherein the controller is configured to regulate the power supply to provide electrical power having a current in the range of about 20,000 to 40,000 amps and a voltage in the range of about 4.5 to 6 vdc to the plurality of contacts during the final flashing stage.

7. The welding system of claim 6, wherein the controller is configured to regulate the power supply to provide electrical power having a current in the range of about 35,000 to 100,000 amps and a voltage in the range of about 5 to 12 vdc to the plurality of contacts during the forging stage.

8. A welding system, comprising:
a power supply;
a forging arrangement configured to hold and move ends of two components to be welded together;
a plurality of contacts connecting the power supply to the two components; and
a controller in communication with the power supply and the forging anangement, the controller being configured to:
regulate the power supply to operate in a constant voltage mode during at least one stage of a single weld cycle;
regulate the power supply to operation in a constant current mode during at least one other stage of the single weld cycle; and
actuate the forging arrangement to move the ends of the two components together during a stage of the single weld cycle.

9. The welding system of claim 8, wherein:
the single weld cycle includes a straight flashing stage, a preheating stage, a final flashing stage, and a forging stage; and
the controller is configured to regulate the power supply to selectively operate in the constant current mode during the straight flashing, preheating, and forging stages, and in the constant voltage mode during the final flashing stage.

10. The welding system of claim 9, wherein the controller is configured to regulate the power supply to provide electrical power having a current in the range of about 80,000 to 85,000 amps and a voltage in the range of up to about 12 vdc to the plurality of contacts during the straight flashing stage.

11. The welding system of claim 10, wherein the controller is configured to regulate the power supply to provide electrical power having a current in the range of about 80,000 to 100,000 amps and a voltage in the range of about 8 to 12 vdc to the plurality of contacts during the preheating stage.

12. The welding system of claim 11, wherein the controller is configured to regulate the power supply to provide electrical power having a current in the range of about 20,000 to 40,000 amps and a voltage in the range of about 4.5 to 6 vdc to the plurality of contacts during the final flashing stage.

13. The welding system of claim 12, wherein the controller is configured to regulate the power supply to provide electrical power having a current in the range of about 35,000 to 100,000 amps and a voltage in the range of about 5 to 12 vdc to the plurality of contacts during the forging stage.

14. A method of flash welding a first component to a second component, comprising:
regulating a power supply in a constant current mode of operation to provide power to ends of the first and second components during at least a first stage of a welding cycle;
regulating the power supply in a constant voltage mode of operation to provide power to ends of the first and second components during at least a second stage of the welding cycle; and
moving the first component into the second component during a third stage of the welding cycle.

15. The method of claim 14, wherein the welding cycle includes a straight flashing stage, a preheating stage, a final flashing stage, and a forging stage.

16. The method of claim 15, wherein:
regulating the power supply in the constant current mode of operation includes regulating the power supply in the constant current mode of operation during the straight flashing, preheating, and forging stages; and
regulating the power supply in the constant voltage mode includes regulating the power supply in the constant voltage mode during the final flashing stage.

17. The method of claim 16, wherein regulating the power supply in the constant current mode of operation during the straight flashing stage includes regulating the power supply to provide electrical power having a current in the range of about 80,000 to 85,000 amps and a voltage in the range of up to about 12 vdc.

18. The method of claim 17, wherein regulating the power supply in the constant current mode of operation during the preheating stage includes regulating the power supply to provide electrical power having a current in the range of about 80,000 to 100,000 amps and a voltage in the range of about 8 to 12 vdc.

19. The method of claim 18, wherein regulating the power supply in the constant voltage mode of operation during the final flashing stage includes regulating the power supply to provide electrical power having a current in the range of about 20,000 to 40,000 amps and a voltage in the range of about 4.5 to 6 vdc.

20. The method of claim 19, wherein regulating the power supply in the constant current mode of operation during the forging stage includes regulating the power supply to provide electrical power having a current in the range of about 35,000 to 100,000 amps and a voltage in the range of about 5 to 12 vdc.
